(19) United States
(12) Patent Application Publication
(10) Pub. No.: US 2006/0078162 A1
(43) Pub. Date: Apr. 13, 2006

(54) System and method for stabilized single moving camera object tracking

(75) Inventor: Siegfried Wonneberger, Munich (DE)

Correspondence Address: VENABLE LLP, P.O. BOX 34385, WASHINGTON, DC, 20045-9998, US

(73) Assignee: DynaPel, Systems, Inc., Fort Myers, FL (US)

(21) Appl. No.: 11/246,261

(22) Filed: Oct. 11, 2005

Related U.S. Application Data
(60) Provisional application No. 60/616,857, filed on Oct. 8, 2004.

(51) Int. Cl. G06K 9/00; H04N 5/228

(52) U.S. Cl. 382/103; 348/208.99

(57) ABSTRACT

A system including a moveable camera adapted to obtain a sequence of video images of an object, a determiner adapted to identify an object border in a current video image of said sequence of video images, said determiner being adapted to determine an object area and a background area based on said object border; an estimator adapted to estimate a camera motion estimate of said moveable camera and to estimate an object motion estimate of the object, said estimator being adapted to generate a camera motion model from said camera motion estimate and being adapted to generate an object motion model from at least one of said object motion estimate and said camera motion model; a stabilizer adapted to adjust at least one video image within said sequence of video images based on said camera motion model; and a controller adapted to control said moveable camera to track the object based on said object motion model and said camera motion model.

### CROSS-REFERENCE TO RELATED APPLICATIONS

This application claims priority to provisional U.S. patent application Ser. No. 60/616,857, filed Oct. 8, 2004, which is hereby incorporated by reference in its entirety.

### FIELD OF THE INVENTION

The invention relates to stabilizing video obtained by a camera. More particularly, this invention relates to controlling a moveable camera and stabilizing video output from the moveable camera.

### BACKGROUND OF THE INVENTION

Tracking an object with a moving camera is a difficult task. When the camera is moving, simple change detection algorithms conventionally used to detect motion in fixed cameras cannot be used to detect object motion. These simple algorithms do not work in moving cameras because the moving camera produces changes all over the image. On the other hand, determining motion models using optical flow techniques can be rather inaccurate. Control commands for moveable cameras based on inaccurate motion models lead to the appearance of unwanted shaking during display of the resulting video.

What is needed is a system that can track a moving object with a moveable camera or can compensate for vehicle motion without producing unwanted shaking in the resulting video.

### SUMMARY OF THE INVENTION

An exemplary embodiment of the invention may include a system for tracking motion of an object, a system for maintaining a moveable camera in an initial direction, and method for tracking a moving object.

The system includes a moveable camera adapted to obtain a sequence of video images of an object, a determiner adapted to identify an object border in a current video image of the sequence of video images, the determiner being adapted to determine an object area and a background area based on the object border; an estimator adapted to estimate a camera motion estimate of the moveable camera and to estimate an object motion estimate of the object, the estimator being adapted to generate a camera motion model from the camera motion estimate and being adapted to generate an object motion model from at least one of the object motion estimate and the camera motion model; a stabilizer adapted to adjust at least one video image within the sequence of video images based on the camera motion model; and a controller adapted to control the moveable camera to track the object based on the object motion model and the camera motion model.

The system may further include an output device adapted to receive the adjusted video image, wherein the stabilizer warps the at least one video image during the adjustment of the at least one video image, wherein the stabilizer is adapted to stabilize the sequence of video images produced by the moveable camera and simultaneously the controller is adapted to control the moveable camera to track the object, wherein the controller is adapted to control the movable camera to maintain the object within the outer border of each video image while the object is within the range of the camera, and wherein the moveable camera is adapted to perform at least one of pan, tilt, and/or zoom.

The system may also include wherein the stabilizer is adapted to generate a correction model from the camera motion model, wherein the stabilizer is adapted to filter the camera motion model and to generate the correction model based on a comparison of the camera motion model and the filtered camera motion model, wherein the stabilizer adjusts at least one of the sequence of video images using the correction model, and wherein the determiner is adapted to adjust the object border in a next video image based on the object motion model.

A system may also include a moveable camera adapted to obtain a sequence of video images, an estimator adapted to generate a camera motion estimate of motion of the moveable camera and to generate a camera motion model from the camera motion estimate; a controller adapted to receive an initial direction of an optical axis, the controller controlling the moveable camera to maintain the optical axis in the initial direction based on the initial direction and the camera motion model; and a stabilizer adapted to adjust the sequence of video images based on the camera motion model to stabilize the sequence of video images.

The system may also include wherein the stabilizer is adapted to stabilize the sequence of video images simultaneously to the controller being adapted to control the moveable camera to maintain the optical axis of the moveable camera in the initial direction, wherein the controller is adapted to control the moveable camera to at least one of pan, tilt, and/or zoom, wherein the stabilizer is adapted to generate a correction model based on the camera motion model, and wherein the stabilizer is adapted to adjust at least one of the sequence of video images using the correction model.

A method may include obtaining, at a moveable camera, a sequence of video images of a scene having an object; identifying an object border within a current video image that substantially surrounds the object; determining a background area and an object area of the current video image in the sequence of video images based on the object border; determining optical flow data of the background area and of the object area; calculating a camera motion model based on the optical flow data of the background area; calculating an object motion model based on the optical flow data of the object area; adjusting the object border based on the object motion model; calculating a correction model based on the camera motion model; and adjusting the current video image based on the correction model.

The method may also include wherein the adjusting the object border further comprises warping the object border based on the object model, wherein adjusting the current video image comprises warping the current video image based on the correction model, controlling the moveable camera to track the object based on the object motion model and on the camera motion model, and outputting the adjusted current video image to an output device.

Moreover, the above features and advantages of the invention are illustrative, and not exhaustive, of those which can be achieved by the invention. Thus, these and other features and advantages of the invention will be apparent from the description herein, both as embodied herein and as modified in view of any variations which will be apparent to those skilled in the art.

### BRIEF DESCRIPTION OF THE DRAWINGS

The foregoing and other features and advantages of the invention will be apparent from the following, more particular description of the exemplary embodiments of the invention, as illustrated in the accompanying drawings. The left most digits in the corresponding reference number indicate the drawing in which an element first appears.

Embodiments of the invention are explained in greater detail by way of the drawings, where the same reference numerals refer to the same or analogous features.

FIG. 1 illustrates an exemplary embodiment of a system according to the present invention;

FIG. 2 illustrates an exemplary embodiment of a video image partitioned into an object area and a background area according to the present invention;

FIG. 3 illustrates an exemplary embodiment of adjusting an object border according to the present invention;

FIG. 4 illustrates an exemplary embodiment of a control unit according to the present invention;

FIG. 5 illustrates an exemplary embodiment of a video stabilizer according to the present invention; and

FIG. 6 illustrates another exemplary embodiment according to the present invention.

### DETAILED DESCRIPTION OF THE PREFERRED EMBODIMENTS

Exemplary embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention.

An exemplary embodiment of the invention may relate to a system for fast automatic object tracking or for vehicle motion compensation using a moveable camera and for presenting a smooth visual impression at a display by stabilizing video output from the moveable camera. In an exemplary embodiment, tracking of the object and stabilization of the output video may be based on a simultaneous determination of camera motion and object motion. While the stabilization of the output video is achieved by compensating for the camera motion, both, the camera motion and the object motion are needed for the control of the moveable camera in order to track the object. In an exemplary embodiment, each video image in a sequence of video images may be captured by the moveable camera and may be partitioned into an object area and a background area through the use of, e.g., but not limited to, optical flow estimations that may be used to create models for object motion and for camera motion, or through a user drawing an object border around an object using a selection device, such as, but not limited to, a mouse or joy-stick. The video sequence, which may be obtained by the moveable camera, may be stabilized by adjusting individual video images with motion corrections, which may be derived from temporally low pass filtering, e.g., but not limited to, a camera motion model to smooth out changes between each video image caused by motion of the moveable camera, according to an exemplary embodiment. Additionally, in an exemplary embodiment, the moveable camera may receive control commands, which may be derived from both the camera motion model and the object motion model, which may be used to track the object of interest and to keep the object of interest within the outer border of each video image while the object is within the range of the camera.

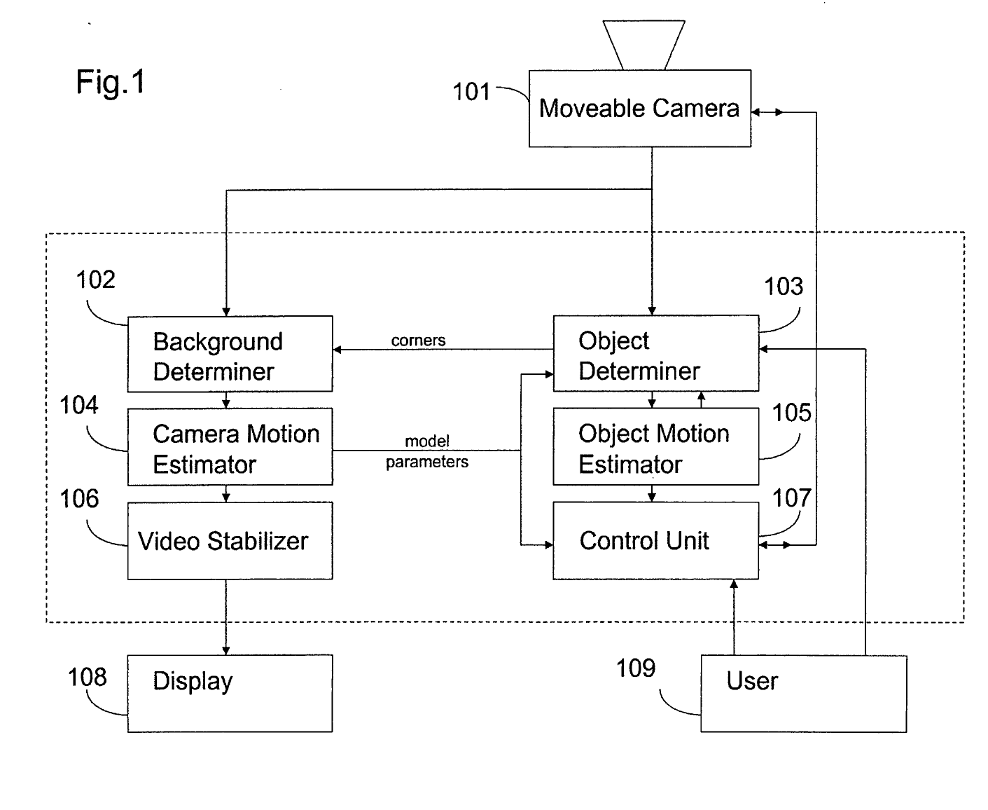

The invention is initially described with reference to FIG. 1. FIG. 1 illustrates an exemplary embodiment of a system according to the present invention. The depicted exemplary embodiment may include a Moveable Camera 101, a Background Determiner 102, an Object Determiner 103, a Camera Motion Estimator 104, an Object Motion Estimator 105, a Video Stabilizer 106, a Control Unit 107, a Display 108, and a User 109. The Camera Motion Estimator 104 and the Object Motion Estimator 105 are illustrated as separate devices in the exemplary embodiment of FIG. 1; however, the Camera Motion Estimator 104 and the Object Motion Estimator 105 may be included in a single device, as will be appreciated by those skilled in the art. Likewise, the Background Determiner 102 and the Object Determiner 103 may be separate devices, as illustrated, or may be a single device. Other device combinations and/or subcombinations are also possible as will be apparent to those skilled in the art.

The Moveable Camera 101 may be adapted to record a scene and to produce a sequence of video images of the scene, where each video image may represent items and objects within the scene at a particular time. In an exemplary embodiment, the Moveable Camera 101 may be a video camera and may be able to perform one or more of, e.g., but not limited to, panning, zooming, and/or tilting, etc. In a further exemplary embodiment, the Moveable Camera 101 may be a Pan-Tilt-Zoom (PTZ) Camera. The Moveable Camera 101 may output the sequence of video images to, e.g., but not limited to, the Background Determiner 102 and to the Object Determiner 103 in an exemplary embodiment.

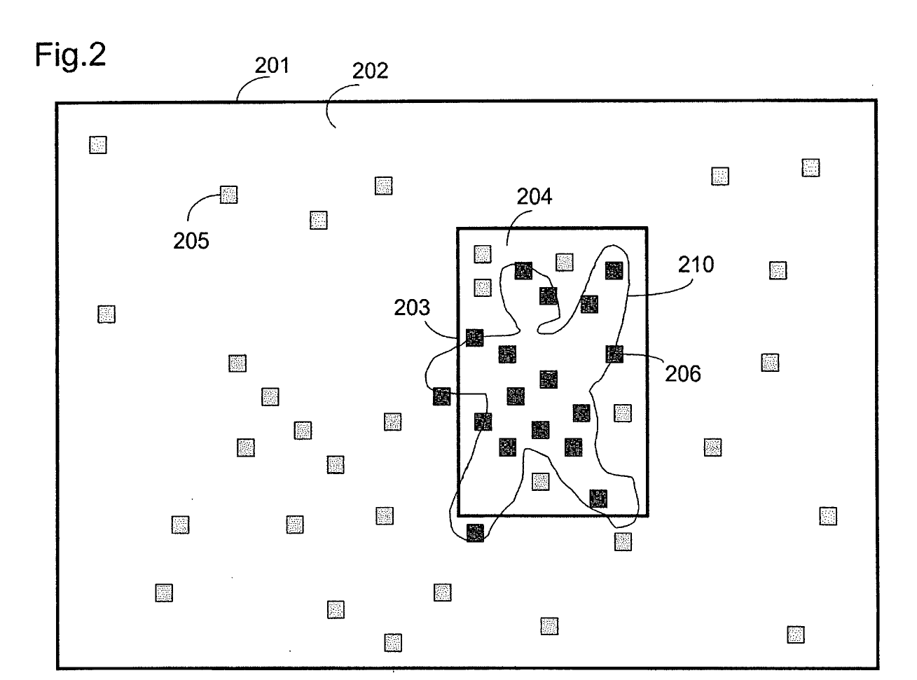

The Object Determiner 103 may receive the sequence of video images from the Moveable Camera 101 and may create a border 203 substantially around the outside of an object 210 of interest within the current video image (see FIG. 2). The border 203 may be, e.g., but not limited to, selected by the User 109 and/or may be automatically determined by adjusting the border of a previous video image using an object motion model, as will be described below in detail. The Object Determiner 103 in an exemplary embodiment may send object area information describing the border 203 to the Background Determiner 102 and to the Object Motion Estimator 105. The object area information may describe, e.g., but not limited to, pixels that may substantially surround the outer side of the object 210. In one embodiment, the Object Determiner 103 may identify a rectangular border and may send object area information describing the four pixels corresponding to the corners of the rectangular border. Other symmetrical and asymmetrical shapes of borders and other numbers of pixels may be included in the object area information, as will be appreciated by those skilled in the art.

The Background Determiner may 102 receive the object area information on the border 203 from the Object Determiner 103 and may receive the sequence of video images from the Moveable Camera 101. Alternatively, the Object Determiner 103 may forward the sequence of video images to the Background Determiner 102. For the current video image, the Background Determiner 102 may use the border 203, which may be identified by the Object Determiner 103, to determine the complement of the object area as background area. In an exemplary embodiment, the area outside of the border 203 within the current video image may be a background area 202 (i.e., the complement), and the area inside of the border 203 within the current video image may be an object area 204 (see FIG. 2). In an alternative embodiment, multiple object areas may be defined when multiple objects are within the video image of a scene and the complement of the multiple object areas is the background area, as will be appreciated by those of skill in the art. The Background Determiner 102 may then forward information on the background area 202 to the Camera Motion Estimator 104.

The Camera Motion Estimator 104 may receive and use the background area information on the background area 202 to estimate a model of the camera motion based on optical flow data calculated between the current video image and one or more of the previous video images. The Camera Motion Estimator 104 then may forward parameters describing the camera motion model to the Video Stabilizer 106, which may temporally filter the parameters and may adjust the current video image in order to, e.g., but not limited to, generate a substantially smooth, non-shaking sequence of video images for display at the Display 108. The Camera Motion Estimator 104 also may forward the camera motion model parameters to the Object Determiner 103 and to the Control Unit 107, in an exemplary embodiment.

While the object area information is being forwarded to the Background Determiner 102, the Object Determiner 103 may simultaneously, independently, and/or consecutively forward the object area information to the Object Motion Estimator 105. The Object Motion Estimator 105 may use the object area information of the object area 204 to estimate a model of object motion by identifying optical flow of the object 210 within the sequence of video images. In one exemplary embodiment, the estimate may use at least the current video image and one or more of the previous video images. Once calculated, the Object Motion Estimator 105 may output the object motion model to the Object Determiner 103 for adjusting the object border in the next image and for controlling motion of the Moveable Camera 101, according to an exemplary embodiment.

As illustrated in the exemplary embodiment of FIG. 1, the Control Unit 107 and the Moveable Camera 101 may communicate back and forth with one another, as indicated by the double-sided arrows in the connection line therebetween. While the object 210 may be within range of the Moveable Camera 101, the Control Unit 107 may forward control commands to control, e.g., but not limited to, panning, zooming, and/or tilting of the Moveable Camera 101 to track the object 210. The range may be all of the possible combinations of camera movement including, e.g., tilting, panning, and/or zooming of the Moveable Camera 101 to obtain video images of a scene. In the other communication direction, the Moveable Camera 101 may transmit information including, e.g., but not limited to, the actual camera position and camera velocity to the Control Unit 107 in order to improve the calculation of the control commands.

FIG. 2 illustrates an exemplary embodiment of a video image partitioned into an object area and a background area according to the present invention. The outer border of the background area 202 may be border 201, which also may represent the outermost recordable viewing area for the Moveable Camera 101. The inner border of the background 202 may be the object border 203. The object border 203 may also be the outer border of object area 204. The object border 203 may define the area substantially surrounding the object 210. The object border 203 may be, e.g., defined by User 109, who draws the border using a mouse or a joy-stick, or may be automatically determined as a result of adjusting the object border 203 of the previous video image.

In FIG. 2, the small squares spread over the video image may represent blocks of pixels having enough texture to be usable for a block-matching motion estimation algorithm for determining reliable motion vectors. Blocks of pixels that have enough texture show corners and edges with high contrast. In contrast, blocks having insufficient texture are more homogeneous. The present invention may use a conventional block-matching algorithm. The block-matching motion algorithm may compare the sum of absolute differences (SAD) of the luminances of the pixels to identify matching blocks in the different images. As illustrated, the brighter blocks 205 belong to the real background and the darker blocks 206 belong to the real object, because they overlap with the real object. 210. In FIG. 2, in an exemplary embodiment, only the outline of the object 210 may be depicted for clarity. As depicted, most of the brighter blocks 205 may be located in the background area 202, but some of the brighter blocks 205 may be located in the object area 204. Conversely, most of the darker blocks 206 may be located in the object area 204, but some of the darker blocks 206 may be located in the background area 202. This may occur since the object border 203 may be only an estimate of the location of the object 210, and some parts of the object 210 may be on the outside of object border depending on the size of the object border 203.

During operation, all of the pixel blocks in the background area 202 may be used by the Camera Motion Estimator 104 to estimate the camera motion model for the motion of the Moveable Camera 101 based on optical flow data. In one embodiment, the estimate of the camera motion model may be based on motion vectors (or displacements) obtained by matching the selected pixel blocks within the current video image with pixel blocks in one or more of the previous video images. This matching process may be supported by additional similar matching processes in corresponding images with rougher spatial resolution. In a robust least squares algorithm, a camera motion model (transformation) T_{current} is determined, which maps the original positions of the pixel blocks to the displaced positions of the matching pixel blocks. The camera motion model may be described by four parameters, which may be used to identify translation, rotation and scale. An advantage of using a robust least square algorithm is that it may guarantee that the contribution of the false dark blocks, belonging to the object 210, will be detected as outliers and thus will not contribute to the camera motion model. Any other algorithm producing a camera motion model, which maps the original positions of the pixel blocks to the displaced positions of the matching pixel blocks, may also be used, as will be appreciated by those skilled in the art.

Likewise, all of the pixel blocks in the object area 204 may be used by the Object Motion Estimator 105 to estimate an object motion model for the motion of object 210 based on optical flow data. In one embodiment, the estimate of the object motion model may be based on motion vectors (or displacements) obtained by matching the selected pixel blocks within the current video image with pixel blocks in one or more of the previous video images. This matching process may be supported by additional similar matching processes in corresponding images with rougher spatial resolution. In a robust least squares algorithm, an object motion model (transformation) M_{current} is determined, which maps the original positions of the pixel blocks to the displaced positions of the matching pixel blocks. The object motion model may be described by four parameters, which may be used to identify translation, rotation and scale, or by just two parameters representing translation only. An advantage of using a robust least square algorithm is that it may guarantee that the contribution of the false bright blocks, belonging to the real background (e.g., the pixels in the video image that do not correspond to the object 210), will be detected as outliers and thus will not contribute to the object motion model. Additionally the camera motion model, calculated before, can be used to identify outliers belonging to the real background, by comparing the motion vectors detected in the object area 204 with corresponding motion vectors calculated from the camera motion model. In one embodiment, the pixel blocks with small deviations may be identified as outliers and may not be used in the least squares algorithm. Alternatively, the object motion model may be derived from the camera motion model and the object border 203.

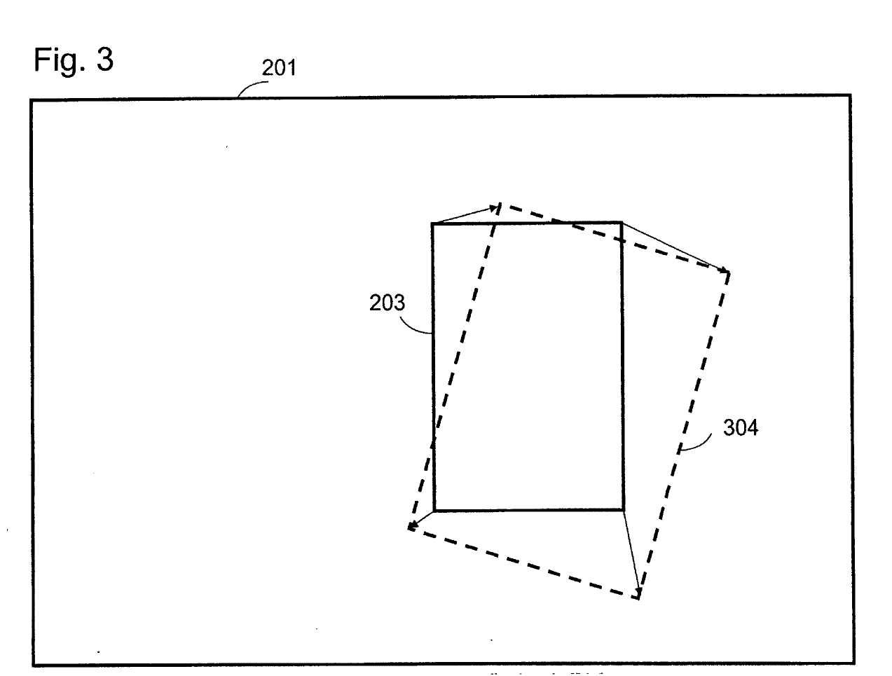

FIG. 3 illustrates an exemplary embodiment of adjusting an object border according to the present invention. As discussed above, the object border 203 may be selected by the User 109, or may be determined by the Object Determiner 103. When the User 109 is not selecting the object border, the Object Determiner 103 may determine the object border 203. Initially, the Object Determiner 103 may identify the moving object 210 by any conventional segmentation algorithm, and then may place the border 203 around the object 210 such that the object 210 may be substantially within the border 203. After the initial border is identified, in subsequent video images, the Object Determiner 103 may receive the object motion model from the Object Motion Estimator 105 to adjust the object border 203. The Object Determiner 103 may use the object motion model to track the change in object motion from one or more of the previous video images to the current video image. Based on monitoring this change, the Object Determiner 103 may adjust the object border 203 to obtain an adjusted object border 304 so that the object 210 may be substantially within the object border 304. Based on the tracked change in position, the Object Determiner 103 may, e.g., but not limited to, rotate, slide, resize, and/or reposition the object border 203 to obtain object border 304. The object border 304 may also be smaller, larger, or the same size as object border 203, depending on the object motion model.

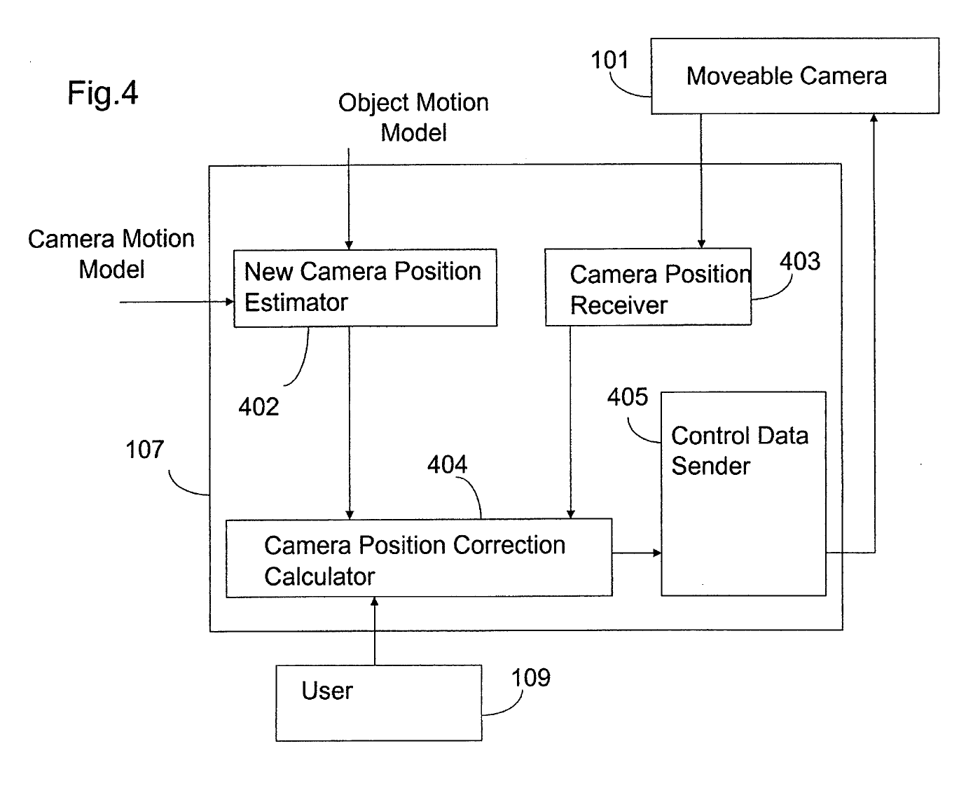

FIG. 4 illustrates an exemplary embodiment of a Control Unit according to the present invention. In an exemplary embodiment, a Control Unit 107 may include a New Camera Position Estimator 402, a Camera Position Receiver 403, a Camera Position Correction Calculator 404, and a Control Data Sender 405. The Control Unit 107 may be operably coupled to the Moveable Camera 101 and may also receive input from the User 109. The Control Unit 107 may receive, at the New Camera Position Estimator 402, the camera motion model from, e.g., but not limited to, the Camera Motion Estimator 104 and/or the object motion model from the Object Motion Estimator 105. From the camera motion model and/or the object motion model, the New Camera Position Estimator 402 may estimate a new camera position thereby taking into account times for calculation, for transfer and for moving the Moveable Camera 101 and may transfer the camera position estimate to the Camera Position Correction Calculator 404. Any estimation technique may be applied, as will be appreciated by those skilled in the art. The new camera position is an estimation and/or prediction of the direction in which the optical axis of the Moveable Camera 101 has to point in order to keep object 210, which may be moving, within range of the Moveable Camera 101 in the next video image. Thus, this may maintain the object 210 within the border 201 of the next video image at the predicted and/or estimated location.

The Camera Position Correction Calculator 404 may also receive the actual camera position that may be forwarded from the Moveable Camera 101 through the Camera Position Receiver 403. In an exemplary embodiment, after receiving the actual camera position, the Camera Position Correction Calculator 404 may compare the actual camera position with the camera position estimate to calculate a position correction. The comparison to calculate the position correction may determine an error in the camera position estimate, and the New Camera Position Estimator 402 may use the error in the camera position estimate to, e.g., but not limited to, update the camera position, and to minimize error between the actual camera position and the camera position estimate. After the position correction is calculated, the position correction may be transferred to the Moveable Camera 101 by a Control Data Sender 405 to, e.g., but not limited to, adjust the position of the Moveable Camera 101. It is noted that FIG. 4 depicts components that may be included within the Control Unit 107 separately. However, more components may be used, or the functionality of the components may be placed into fewer components, as will be appreciated by those of skill in the art.

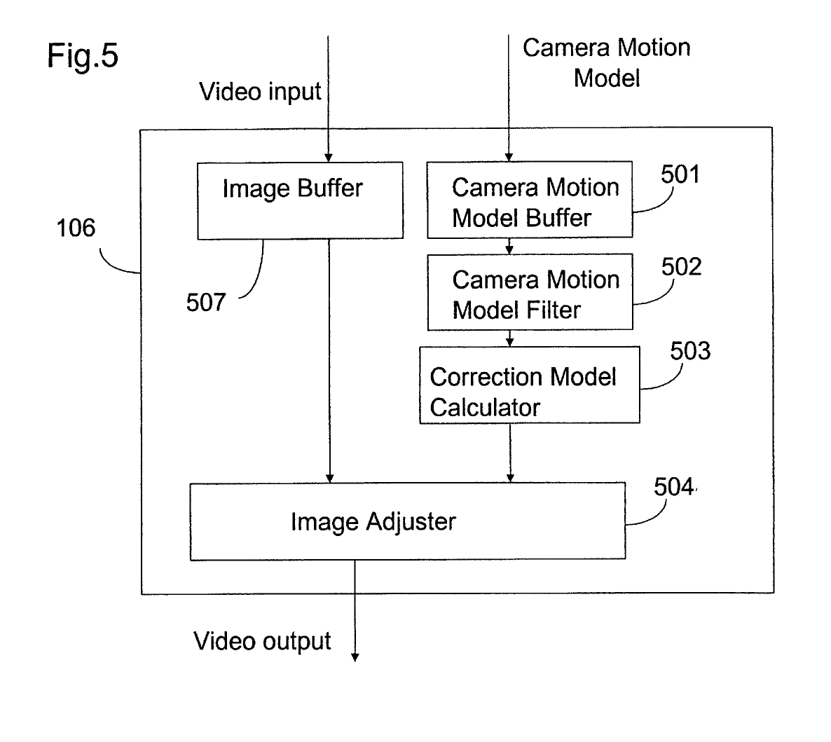

FIG. 5 illustrates an exemplary embodiment of a video stabilizer according to the present invention. As depicted, Video Stabilizer 106 may include, in an exemplary embodiment, a Camera Motion Model Buffer 501, a Camera Motion Model Filter 502, a Correction Model Calculator 503, an Image Adjuster 504, and an Image Buffer 507. At one input, the Video Stabilizer 106 may be adapted to receive a sequence of video images, and at another input, the Video Stabilizer 106 may be adapted to receive a sequence of camera motion models corresponding to the current video image and one or more of the previous video images in the sequence of video images. The Video Stabilizer 106 may be adapted to adjust each current video image using the camera motion models and to output the adjusted video image to, e.g., but not limited to, the Display 108.

Initially, the sequence of video input images may be received and stored in an Image Buffer 507, which may be adapted to output each stored video image to an Image Adjuster 504. The sequence of camera motion models may also be received at a separate input and may be stored at a Camera Motion Model Buffer 501. The Camera Motion Model Buffer 501 may be adapted to output the current camera motion model to a Camera Motion Model Filter 502. The Camera Motion Model Filter 502 may temporally filter the parameters of the current camera motion model (e.g., but not limited to, generated from the current video image and at least one or more of the previous video images) together with the corresponding parameters of previous camera motion models from a sequence of previous images stored in the Camera Motion Model Buffer 501 using, e.g., but not limited to, a special low pass Finite Impulse Response (FIR)-filter. The special low pass FIR-filter may be, for example, but not limited to, a Blackman-filter. In general, any low pass filter may be used, as will be appreciated by those skilled in the art. The special low pass FIR-filter may filter the parameters of the current camera motion model with the corresponding parameters of a sequence of previous images to remove any large parameter fluctuations or differences between the parameters of the current camera motion model and of the previous camera motion models.

After filtering the current camera motion model, the Camera Motion Model Filter 502 may output the filtered current camera motion model T_{filtered} together with the current camera motion model T_{current} to a Correction Model Calculator 503. The Correction Model Calculator 503 may calculate the current correction model ΔT_{current} from the current camera motion model T_{current} and the filtered current camera motion model T_{filtered} together with the previous correction model ΔTₚᵣₑᵥᵢₒᵤₛ by the composition ΔT_{current}=T_{filtered}∘ΔTₚᵣₑᵥᵢₒᵤₛ∘T_{current}⁻¹. The correction model may be adapted to correct, e.g., shaking in the sequence of video images that may appear as a result of movement by, e.g., the Moveable Camera 101 and/or a vehicle or a device on which the Moveable Camera 101 is mounted.

Once calculated, the Correction Model Calculator 503 may forward the correction model to the Image Adjuster 504. The Image Adjuster 504 may adjust the current video image using the correction model to produce a video output such that successive video images in the video output to Display 108 may appear substantially smooth and non-shaking to a user. The Image Adjuster 504 may adjust the individual video images using the correction model, e.g., but not limited to, by a correction warp. A correction warp is a transformation of a video image to a corrected image, wherein the value of each pixel in the corrected image is interpolated from the values of the pixels in the neighborhood of a point in the image, displaced from the pixel by a motion vector derived from the correction model.

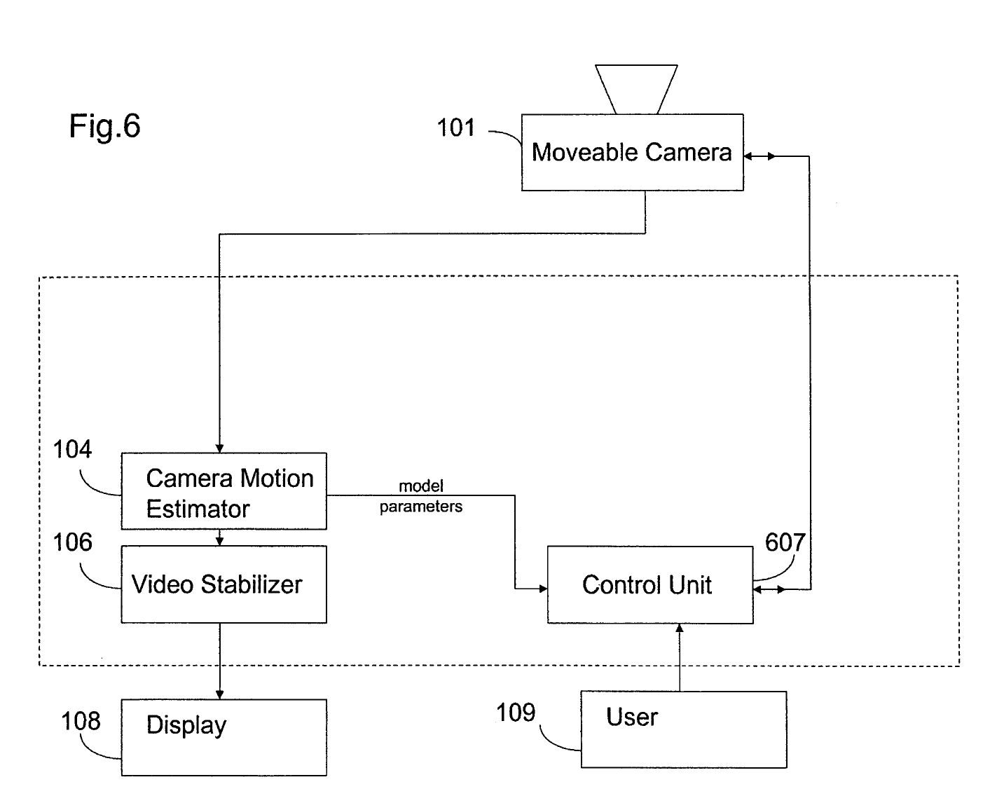

FIG. 6 illustrates a further exemplary embodiment of a system according to the present invention. This exemplary embodiment may include a Moveable Camera 101, a Camera Motion Estimator 104, a Video Stabilizer 106, a Control Unit 607, a Display 108, and a User 109. In an exemplary embodiment, instead of performing object detection, the Moveable Camera 101 may be automatically controlled by the Control Unit 607 to ensure that the optical axis of the camera may be always directed in the same direction. In anembodiment, the Moveable Camera 101 may be placed on a moving vehicle the User 109 may wish to keep the Moveable Camera 101 directed toward a particular scene. The initial direction of the optical axis may be selected and may be fixed by the User 109 to maintain the Moveable Camera 101 directed toward a particular scene. In one exemplary embodiment, the initial direction of the optical axis is initiated when the user presses a start button.

In contrast with the exemplary embodiment depicted in FIG. 1, the exemplary embodiment of FIG. 6 may not include devices for object determination, background determination, or object motion estimation. Instead, the entire video image may define a background area that may be used to generate a camera motion estimate. The Camera Motion Estimator 104 may generate a camera motion estimate based one the background area to generate a camera motion model. The Camera Motion Estimator 104 may forward the camera motion model and the camera motion model parameters to the Control Unit 607. The Control Unit 607 may receive the camera motion model and the parameters to control the Moveable Camera 101 so that the optical axis of the camera may always be directed in the same direction in successive video images. In an exemplary embodiment, the Control Unit 607 may receive the camera motion model and may create control data for the Moveable Camera 101 to compensate for the camera motion in the video output, as discussed above. In an embodiment, the camera motion may also include the motion of the vehicle. The Camera Motion Estimator 104 may also forward the camera motion model and the camera motion model parameters to the Video Stabilizer 106. The Video Stabilizer 106 may adjust the current video image, such as by warping the current video image, based on the camera motion model, as discussed above. This embodiment may be used to compensate for any type of vehicle motion, such as, but not limited to, maintaining a stable video image (and hence, video output) of a beach while the Moveable Camera 101 moves on a boat, or maintaining an image in view of a scene as a car moves relative to the scene. Other alternative vehicle motions may be compensated for, as will be appreciated by those of skill in the art.

The exemplary embodiment and examples discussed herein are non-limiting examples.

The invention is described in detail with respect to exemplary embodiments, and it will now be apparent from the foregoing to those skilled in the art that changes and modifications may be made without departing from the invention in its broader aspects, and the invention, therefore, as defined in the claims is intended to cover all such changes and modifications as fall within the true spirit of the invention.

I claim:

1. A system comprising:
a moveable camera adapted to obtain a sequence of video images of an object;
a determiner adapted to identify an object border in a current video image of said sequence of video images, said determiner being adapted to determine an object area and a background area based on said object border;
an estimator adapted to estimate a camera motion estimate of said moveable camera based on said background area and to estimate an object motion estimate of the object based on said object area, said estimator being adapted to generate a camera motion model from said camera motion estimate and being adapted to generate an object motion model from at least one of said object motion estimate and said camera motion model;
a stabilizer adapted to adjust at least one video image within said sequence of video images based on said camera motion model; and
a controller adapted to control said moveable camera to track the object based on said object motion model and said camera motion model.

2. The system of claim 1, further comprising: an output device adapted to receive said adjusted video image.

3. The system of claim 1, wherein said stabilizer warps said at least one video image during said adjustment of said at least one video image.

4. The system of claim 1, wherein said stabilizer is adapted to stabilize said sequence of video images produced by said moveable camera and simultaneously said controller is adapted to control said moveable camera to track the object.

5. The system of claim 1, wherein said controller is adapted to control said movable camera to maintain the object within the outer border of each video image while the object is within the range of the camera.

6. The system of claim 1, wherein said moveable camera is adapted to perform at least one of pan, tilt, and/or zoom.

7. The system of claim 1, wherein said stabilizer is adapted to generate a correction model from said camera motion model.

8. The system of claim 7, wherein said stabilizer is adapted to filter said camera motion model and to generate said correction model based on a comparison of said camera motion model and said filtered camera motion model.

9. The system of claim 8, wherein said stabilizer adjusts at least one of said sequence of video images using said correction model.

10. The system of claim 1, wherein said determiner is adapted to adjust said object border in a next video image based on said object motion model.

11. A system comprising:
a moveable camera adapted to obtain a sequence of video images,
an estimator adapted to generate a camera motion estimate of motion of said moveable camera and to generate a camera motion model from said camera motion estimate;
a controller adapted to receive an initial direction of an optical axis, said controller controlling said moveable camera to maintain the optical axis in the initial direction based on the initial direction and said camera motion model; and
a stabilizer adapted to adjust said sequence of video images based on said camera motion model to stabilize said sequence of video images.

12. The system of claim 11, wherein said stabilizer is adapted to stabilize said sequence of video images simultaneously to said controller being adapted to control said moveable camera to maintain the optical axis of said moveable camera in the initial direction.

13. The system of claim 11, wherein said controller is adapted to control said moveable camera to at least one of pan, tilt, and/or zoom.

14. The system of claim 11, wherein said stabilizer is adapted to generate a correction model based on said camera motion model.

15. The system of claim 14, wherein said stabilizer is adapted to adjust at least one of said sequence of video images using said correction model.

16. A method comprising:
obtaining, at a moveable camera, a sequence of video images of a scene having an object;
identifying an object border within a current video image that substantially surrounds said object;
determining a background area and an object area of said current video image in said sequence of video images based on said object border;
determining optical flow data of said background area and of said object area;
calculating a camera motion model based on said optical flow data of said background area;
calculating an object motion model based on said optical flow data of said object area;
adjusting said object border based on said object motion model;
calculating a correction model based on said camera motion model; and
adjusting said current video image based on said correction model.

17. The method of claim 16, wherein said adjusting said object border further comprises warping the object border based on said object model.

18. The method of claim 16, wherein adjusting said current video image comprises warping said current video image based on said correction model.

19. The method of claim 16, further comprising:
controlling said moveable camera to track said object based on said object motion model and on said camera motion model.

20. The method of claim 16, further comprising:
outputting said adjusted current video image to an output device.
